(19) United States
(12) Patent Application Publication
(10) Pub. No.: US 2013/0315416 A1
(43) Pub. Date: Nov. 28, 2013

(54) DEVICE CONNECTING MULTIPLE AUDIO SOURCES OVER WIRELESS CONNECTIONS TO AMPLIFIERS AND SPEAKERS

(71) Applicant: David Nakayama, Watertown, MA (US)

(72) Inventor: David Nakayama, Watertown, MA (US)

(21) Appl. No.: 13/477,567

(22) Filed: May 22, 2012

(51) Int. Cl. H04B 7/00

(52) U.S. Cl. 381/77

(57) ABSTRACT

An audio device connects multiple audio sources to speakers. The audio device has an audio input for receiving the output of a wireless receiver, an audio channel including an amplifier that processes the audio input to provide an audio signal that is directed to the speakers. The audio channel also can include a digital-to-analog converter and/or line level switch. The line level switch enables the audio device to direct either the audio from a line level input or the wireless audio device to the speakers. The audio device can have a housing, which has a recess that receives the wireless audio device. In the recess, a receptacle is located to connect to a power plug of a wireless receiver. Another connector is located in the recess to connect the audio output of the wireless receiver to the audio input of the audio device.

### BACKGROUND

A variety of technologies are available for allowing people to have sophisticated home and office audio systems. People often want to be able to play audio from multiple different sources, such as from a music collection or from a video system, such as television or video recordings. The audio is played back on one or more sets of speakers in their home or office, which people also want to be able to select.

In a typical installation, a variety of audio sources are connected into one system that acts a controller. The controller is used to select an audio source and a destination (i.e. a set of speakers) on which the audio will be played. The controller typically has an associated remote control that allows a person to select the audio source and destination.

### SUMMARY

This Summary introduces concepts in a simplified form that are further described below in the Detailed Description. This Summary is neither intended to identify essential features of the claimed subject matter, nor to limit the scope of the claimed subject matter.

An audio device connects to multiple audio sources over a wireless connection to receive audio data. Received audio data is, in turn, output to speakers that are connected to the audio device. Multiple such audio devices can be used in a home or office.

In one implementation, the device includes a wireless receiver which provides an audio output, one or more audio processing channels connected to receive and process that audio output, and speakers connected to the audio processing channels.

The wireless receiver can be implemented using a wireless network hub that has a power connection, a wireless receiver, and an audio output. The wireless network hub can be selected as a playback device by an audio source. After selection, the wireless network hub receives audio from the audio source and plays the audio through its audio output. This audio output is connected to the audio processing channels of the audio device which connect to the speakers.

The audio processing channel can include a line level switch, so that a line level input to the audio device can be selected. The other input to the switch can be the audio output of the wireless receiver. The output of the switch can be input to an amplifier, the output of which is provided to the speakers. If the audio output of the wireless receiver is digital, and if the line level switch is an analog switch, then a digital-to-analog converter input can receive the output of the wireless receiver, and its output can be input to the line level switch. The device also can include a power supply and a receptacle for connecting to a power plug of the wireless receiver to provide power to the wireless receiver.

Thus, in one aspect, an audio device that connects multiple audio sources to speakers comprises an audio input for receiving the output of a wireless receiver, an audio channel including an amplifier that processes the audio input to provide an audio signal, and connectors, connected to receive the audio signal, that can be connected to speakers. The audio channel can also include a digital-to-analog converter and/or line level switch. The line level switch enables the audio device to direct either the audio from a line level input or the wireless audio device to the speakers.

The audio device can have a housing, which has a recess that receives the wireless audio device. In the recess, a receptacle is located to connect to a power plug of a wireless receiver. Another connector is located in the recess to connect the audio output of the wireless receiver to the audio input of the audio device. After the wireless receiver is connected in the recess of the audio device, the audio device can playback audio received through the wireless receiver.

In the following description, reference is made to the accompanying drawings which form a part hereof, and in which are shown, by way of illustration, specific example implementations of a device. Other implementations may be made within, and the example implementations are not intended to limit, the scope of the claimed subject matter.

### BRIEF DESCRIPTION OF THE DRAWINGS

FIG. 1 is a block diagram of an audio system with an audio device that connects multiple wireless audio sources to speakers.

FIG. 2 is a more detailed block diagram of an example implementation of the audio device of FIG. 1.

FIG. 3 is a more detailed block diagram of another example implementation of the audio device of FIG. 1.

FIGS. 4-10 illustrate an example housing for such an audio device.

### DETAILED DESCRIPTION

The following section describes an example environment in which an audio device connects multiple wireless audio sources to an amplifier or speakers.

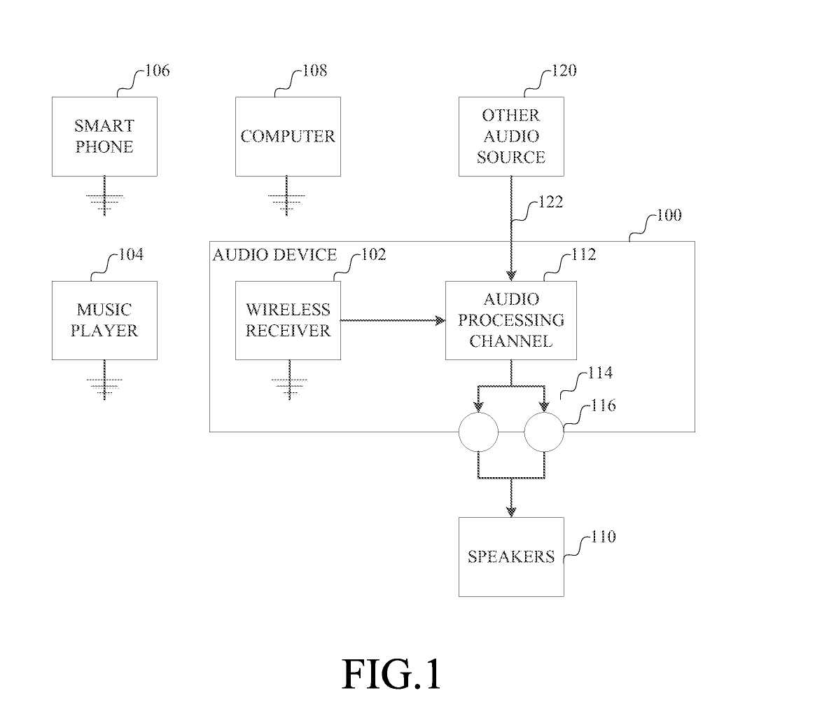

Referring to FIG. 1, an audio device 100 has a wireless receiver 102 through which audio data is received from various audio sources. In FIG. 1, example audio sources are a music player 104, a smart phone 106 and a computer 108.

The audio source can be any device that outputs audio data over a wireless connection, such as the AirPlay wireless technology from Apple Computer, Inc., or Bluetooth wireless technology. Example audio sources include, but are not limited to, an iPod music player, an iPhone smart phone, a MacBook notebook computer, an iPad tablet computer or other similar devices from other manufacturers.

The wireless receiver is a receiver that matches the wireless technology of the audio source. Thus the wireless receiver can be connected to receive audio data wirelessly from an audio source. The wireless receiver can be implemented, for example, using a wireless network hub that has a power connection, a wireless receiver, and an audio output. For example, for audio sources using the AirPlay wireless technology, the wireless receiver can implement an AirPlay wireless receiver. An example of a commercially available wireless receiver that can be used is an AirPort Express wireless hub, which is based on the IEEE 802.11n specification. AirPort Express uses the Bonjour technology in the OS X operating system. If the audio sources are AirPort-equipped, then the audio sources and the AirPort Express wireless hub discover each other by virtue of being in range of the wireless network. A user can select the wireless network hub as a playback device through the audio source. After selection, the wireless network hub receives audio from the audio source and plays the received audio through its audio output.

The wireless receiver 102 provides an audio output which is input to one or more audio processing channels 112. The audio processing channel receives and processes the audio output, and provides an audio signal 114 to connectors 116 that are configured to connect with speakers. Speakers 110 are connected to the connectors 108 to receive audio signals. While the connection to the speakers is shown by lines, such connections can be wired or wireless.

The audio processing channel 112 also can receive an alternate audio input 122, such as a line level analog audio input, from another audio source 120, such as a television. The audio signal 114 output from the audio processing channel can be either from the line level input or the wireless receiver, or a combination of both.

The device can include multiple audio channels and multiple connectors for connecting to multiple sets of speakers. An installation could include multiple audio devices, each connected to different sets of speakers, to allow different audio sources to play on different sets of speakers.

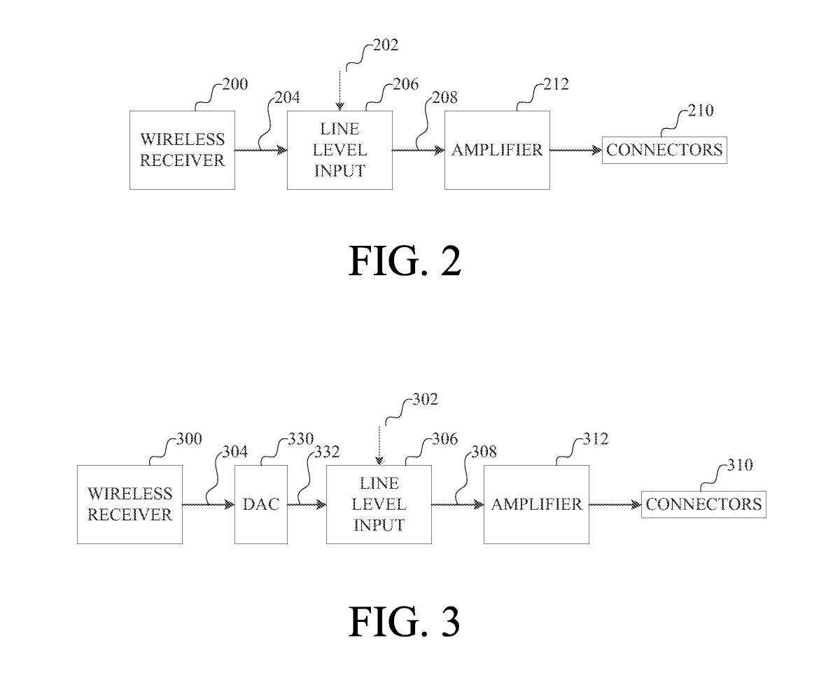

Given this context, an example implementation of the audio device will be described in more detail in connection with FIGS. 2-10.

In FIG. 2, an implementation of the audio device receives an analog audio signal 204 from the wireless receiver 200, and an analog line level input 202, such as from a television (not shown). The audio signal 204 from the wireless receiver is one input to a line level switch 206; the line level input 202 is another input to the line level switch 206. Other processing can occur between the wireless receiver and the line level switch. Thus, the line level switch has a first input connected to receive a signal originating from the output of the wireless receiver and a second input connected to receive a line level input. The line level switch has an output 208, which provides either the audio signal 204 or the line level input 202 as an output. For example, music can be playing through the wireless receiver and audio from a television can be received through the line level input 202. In some implementations, the audio from one source can be played back when the audio from the other source stops playing. For example television audio can be turned on when wireless playback ceases. An example device that has suitable components to implement a line level switch is the LL-One line level A/B switching module available from SpeakerCraft LLC, of Riverside, Calif. Other line level switches also can be used. The output 208 of switch 206 is input to an amplifier 212. An example device that has suitable components to implement an amplifier is the Zamp v.3 two channel zone amplifier from Parasound Products, Inc., of San Francisco, Calif. Other amplifiers can also be used. The output of the amplifier 212 is then connected to connectors 210 that are mounted on a housing (not shown) of the device, to allow for connection to speakers.

In FIG. 3, an implementation of the audio device receives a digital audio signal 304 from the wireless receiver 300, and an analog line level input 302, such as from a television. The audio signal 304 from the wireless receiver is input to a digital to analog converter 330, which provides an audio signal 332 as an output. The audio signal 332 is connected to one input of a line level switch 306; the line level input 302 is another input to the line level switch 306. Thus the line level switch has a first input connected to receive a signal originating from the output of the wireless receiver and a second input connected to receive a line level input. The line level switch has an output 308, which provides the audio signal 332 or the line level input 302 as its output. The output 308 of switch 306 is input to an amplifier 312. The output of the amplifier 312 is then connected to connectors 310 that are mounted on a housing (not shown) of the device, to allow for connection to speakers. The construction of the audio device in FIG. 3 can be similar to that of FIG. 2, with the addition of the digital-to-analog converter.

In both implementations of FIG. 2 and FIG. 3, the wireless receiver can have an audio output connector that connects to a mating connector on the audio device, to enable the audio device to receive the audio output. In the case where the wireless receiver is an AirPort Express device from Apple Computer, Inc., the connector can be 3.5-mm audio minijack for analog or optical digital sound. In such an implementation, the connector on the audio device can be either an analog connector (e.g., FIG. 2) or an optical digital connector (e.g., FIG. 3).

In both implementations of FIG. 2 and FIG. 3, the audio device can have a power supply that connects to standard electric power sources (100-240V AC, 50-60 Hz) through a standard power plug. The power supply converts input power to appropriate levels used by the electrical components in the audio device. The wireless receiver may have its own power supply and plug (such as a NEMA 1 or NEMA 5 plug) for connection to a standard receptacle (such as a NEMA 1 or NEMA 5 receptacle), which is the case for an AirPort Express device. In such an implementation, the audio device can include a receptacle, into which the plug of the wireless receiver is inserted, to allow the audio device to power the wireless receiver.

The audio device in this implementation has a housing that has an audio connector that connects to the audio connector of the wireless receiver, and a receptacle that connects to the power plug of the wireless receiver. This housing contains the components described above in connection with FIGS. 2 and 3 (save for the wireless receiver which connects to it through the audio connector and receptacle). The housing also has connectors for connecting to the speakers as described above. Capacitors and/or other circuitry also could be provided to improve the sound quality available from the audio device.

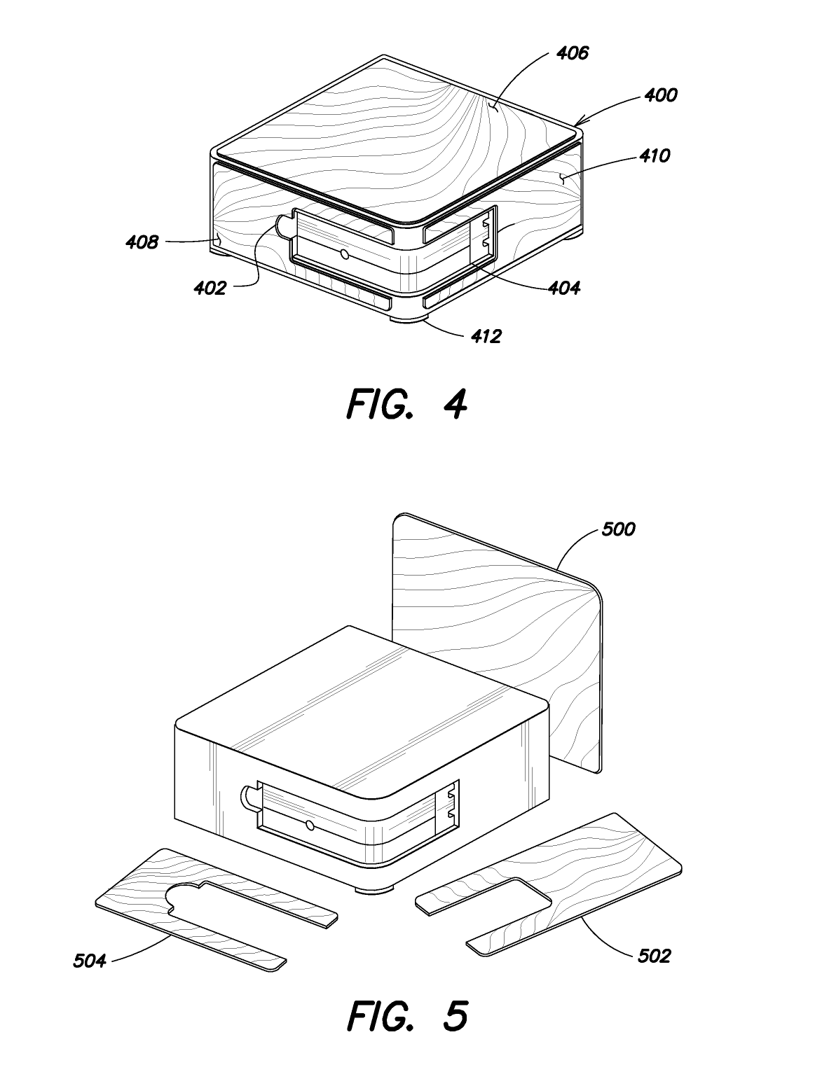

Referring now to FIGS. 4-10, an example housing will now be described.

FIG. 4 is a perspective view of an implementation of the audio device 400, which has a recess 402 into which a wireless receiver 404 is accepted. The housing has a top face 406, four side faces (of which two 408 and 410 are shown) and a bottom face (not shown). Each face can be made of ferrometallic material such that magnetic feet 412 can be placed at each corner of the face. The orientation of the device thus can be customized by the user.

As shown in FIG. 5, each face can have a covering 500, 502, 504. Different colors, patterns and textures can be used on the coverings so as to enable the user to customize the look of the device. For example, the device can be made to look like a book, wood paneling, brick or other material to allow it to blend in with its surroundings.

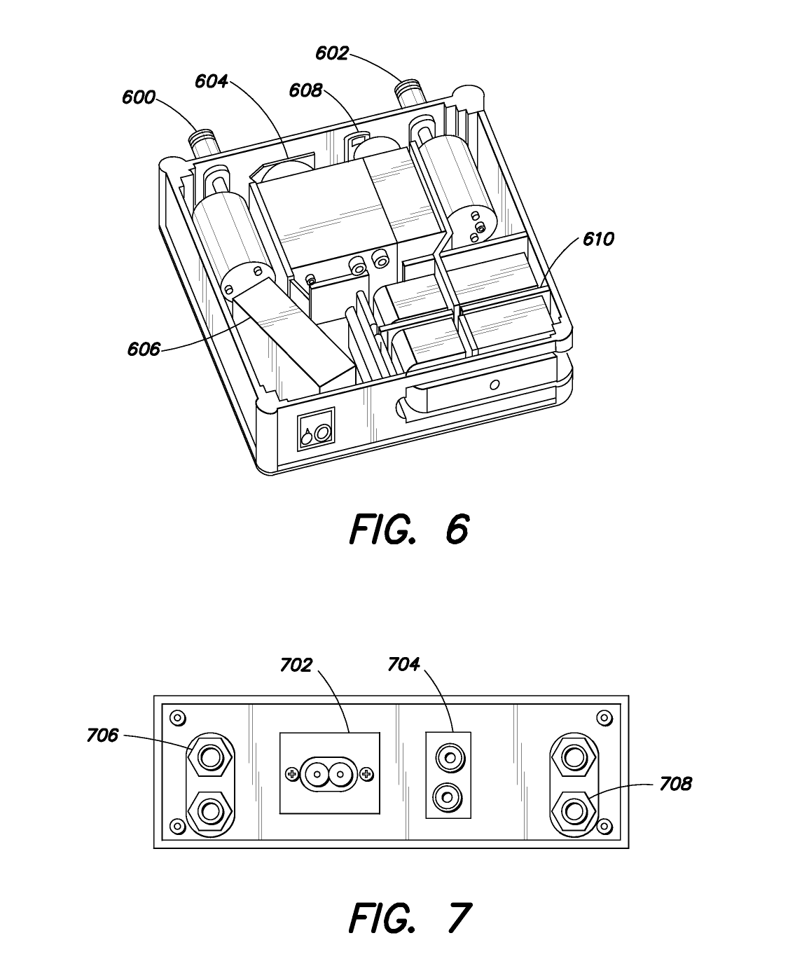

Inside of the housing, as shown in FIG. 6, connections are provided at 600 and 602 for connecting the housing to speakers. Although connections for wired speakers are shown in FIG. 6, other connections can be used. Circuitry to implement a line level switch and amplifier can be provided at 604 and 606, and a power supply at 608. The recess for receiving the wireless receiver also is defined by walls 610 in the housing.

A back panel (one of four side panels) is shown in FIG. 7. Connectors for power 702, for a line input 704, and for speakers 706, 708 are mounted on the external surface of this panel of the housing. More speaker connectors and more line input connectors can be provided to allow for more input sources and more speakers.

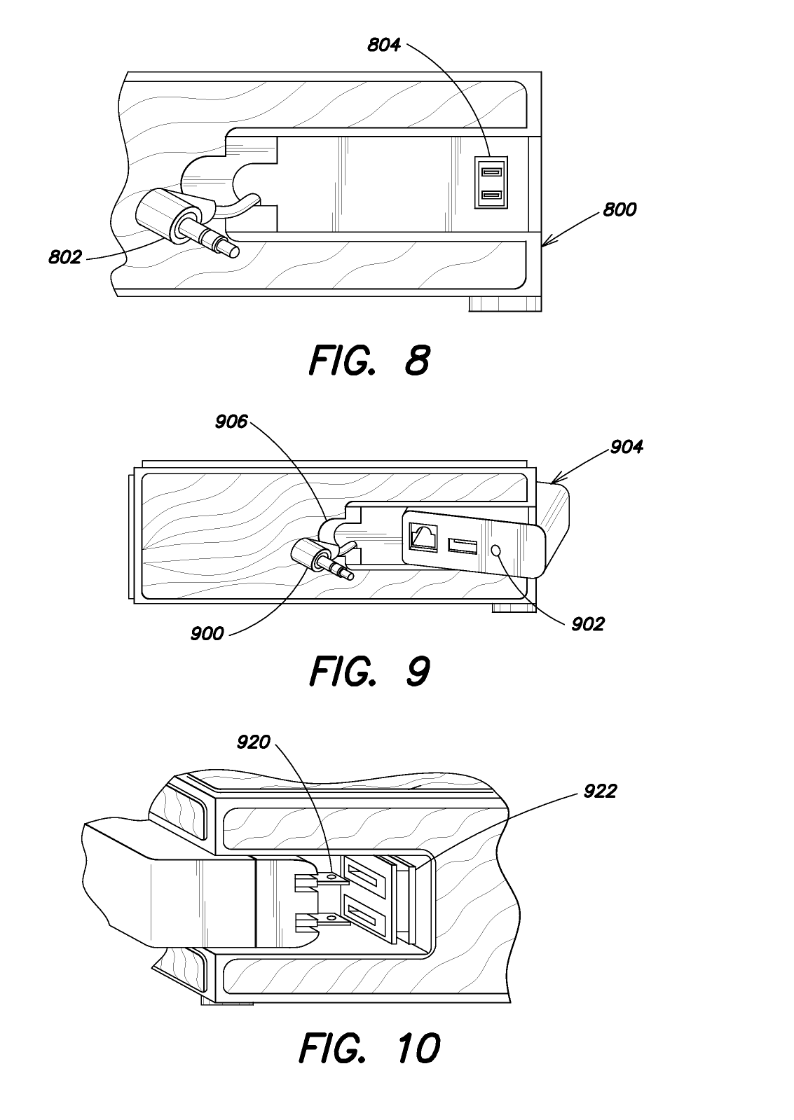

FIG. 8 illustrates more details of the recess 800 for receiving the wireless receiver. The implementation shown if FIG. 8 is designed to receive an AirPort Express wireless hub. The recess includes a connector 802, mounted on an external surface of the recess, which plugs into the audio output of the wireless receiver, which in turn provides an input to the audio processing channel in the audio device. In this implementation a common analog audio connector is shown. Other implementations include, but are not limited to, optical and digital connectors. The recess also includes a receptacle 804 into which a power plug on the wireless receiver is inserted. This receptacle is connected to receive power from the audio device (which in turn is powered through its power input, such as shown at 702 in FIG. 7).

FIGS. 9 and 10 illustrate the insertion of the wireless receiver into the audio device. In FIG. 9, the wireless receiver 904 is placed into the recess 906. The audio connector 900 is inserted into the audio jack 902 of the wireless receiver. Then, as shown in FIG. 10, the plugs 920 of the wireless receiver are aligned with and inserted into the receptacle 922. After insertion, the combined audio device and wireless receiver appear as shown in FIG. 4.

A user can install a power cord (at 702 in FIG. 7), line inputs (such as by connecting inputs 704 to an audio output of a television), and speakers (at 706 and 708). Any kind of speakers can be used.

A typical user can have a smart phone, music player, tablet computer, notebook or laptop computer as well as a television to provide audio sources to this audio device. In an implementation the uses the AirPort Express wireless hub as the wireless receiver, and the wireless audio sources are similarly Apple products, the user can simply select the audio device as the wireless destination to which the audio source plays by selecting that audio device's AirPort express device as the wireless destination for playback.

Such an audio device provides flexibility in design of a home or office audio system, while enabling the audio system to have simple music selection and control. The user can set up an audio system using any speakers, providing significant flexibility in the design.

As an example scenario, a user can turn on music on a music player and plug in the music player to charge, while the user does something else, such as work on a computer. On that computer, the user can open an audio controller to adjust the playback volume on the audio device. The user could also change the playback source to the computer. If the user turns on the television, the audio system automatically switches over to playing the audio from the television. With multiple audio devices and multiple audio sources, a user can select, for any given audio source being used, the audio device that is in range to which the user wishes to play audio. For example, a user could be watching a video on a tablet computer in one room with audio being played back on speakers in that room, and then switch playback to a different audio device and set of speakers after moving into another room, simply by changing, on the tablet computer, the audio device to which the tablet computer is wirelessly connected. A variety of other usage scenarios are possible and the invention is not limited to those described herein.

Other devices with other wireless protocols also can be used and the invention is not limited to those described herein.

The subject matter defined in the appended claims is not limited to the specific implementations described above, which have been presented by way of example only.

What is claimed is:

1. An audio device comprising:
an audio input for receiving an audio output from a wireless receiver, wherein the wireless receiver can be connected to receive audio data wirelessly from an audio source and play received audio to the audio output;
an audio channel that processes the audio input to provide an audio signal; and
connectors connected to the audio signal;
wherein the connectors are configured to connect to speakers.

2. The audio device of claim 1, wherein the audio channel comprises an amplifier.

3. The audio device of claim 2, wherein the audio channel further includes a digital-to-analog converter.

4. The audio device of claim 2, wherein the audio channel further includes a line level switch.

5. The audio device of claim 4, wherein the line level switch has a first input connected to receive an audio signal originating from the audio output of the wireless receiver and a second input connected to a line level input.

6. The audio device of claim 1, further comprising a housing having an external surface, on which audio connectors are mounted for connection to the audio output of the wireless receiver, and on which speaker connectors are mounted for connection to speakers.

7. The audio device of claim 6, wherein the housing further comprises line level connectors mounted on an external surface for connection to a line level input.

8. The audio device of claim 6, wherein the housing has a recess that receives the wireless receiver.

9. The audio device of claim 8, wherein the recess has an external surface on which a receptacle is located to connect to a power plug of the wireless receiver.

10. The audio device of claim 8, wherein the connector that connects to the audio output of the wireless receiver is mounted in the recess.

11. A audio system comprising:
a wireless receiver having an audio output;
a plurality of audio sources that transmit audio data wirelessly to the wireless receiver;
wherein the wireless receiver can be connected to receive audio data wirelessly from a selected one of the audio sources and play received audio to the audio output;
an audio device comprising:
an audio input for receiving the audio output from the wireless receiver,
an audio channel that processes the audio input to provide an audio signal, and
connectors connected to the audio signal; and
speakers connected to the connectors.

12. The audio system of claim 11, wherein the audio channel comprises an amplifier.

13. The audio system of claim 12, wherein the audio channel further includes a digital-to-analog converter.

14. The audio system of claim 12, wherein the audio channel further includes a line level switch.

15. The audio system of claim 14, wherein the line level switch has a first input connected to receive an audio signal originating from the audio output of the wireless receiver and a second input connected to a line level input.

16. The audio system of claim 11, wherein the audio device further comprises a housing having an external surface, on which audio connectors are mounted for connection to the audio output of the wireless receiver, and on which speaker connectors are mounted for connection to speakers.

17. The audio system of claim 16, wherein the housing further comprises line level connectors mounted on an external surface for connection to a line level input.

18. The audio system of claim 16, wherein the housing has a recess that receives the wireless receiver.

19. The audio system of claim 18, wherein the recess has an external surface on which a receptacle is located to connect to a power plug of the wireless receiver.

20. The audio system of claim 18, wherein the connector that connects to the audio output of the wireless receiver is mounted in the recess.
